(19) United States
(12) Patent Application Publication
(10) Pub. No.: US 2026/0004950 A1
(43) Pub. Date: Jan. 1, 2026

(54) SILICONE FREE FIRE SAFETY WIRE CONSTRUCTION

(71) Applicant: Radix Wire & Cable, LLC, Glenwillow, OH (US)

(72) Inventor: Jay H. OSBORNE, JR., Hiram, OH (US)

(21) Appl. No.: 18/760,538

(22) Filed: Jul. 1, 2024

(51) Int. Cl. H01B 7/18; H01B 3/04; H01B 3/44; H01B 7/02; H01B 7/42

(52) U.S. Cl. CPC H01B 7/1855; H01B 3/04; H01B 3/441; H01B 7/025; H01B 7/0291; H01B 7/186; H01B 7/187; H01B 7/42

(57) ABSTRACT

An electric wire is disclosed having a metal conductor, a first synthetic heat stable tape layer in direct contact with the metal conductor, wherein the first synthetic heat stable tape layer has a first edge and a second edge, wherein the first edge and the second edge are substantially parallel to one another, wherein the second edge overlaps the first edge by at least 180 degrees on a cross-sectional view, a second synthetic heat stable tape layer, wherein the second synthetic heat stable tape layer is helically wrapped around the first synthetic heat stable layer, a third synthetic heat stable tape layer, wherein the third synthetic heat stable tape layer is helically wrapped around the second synthetic heat stable layer, wherein electric wire contains no silicone, and an extruded layer, wherein the extruded layer is extruded over the second synthetic heat stable tape layer.

### I. BACKGROUND

### A. Field

The present teachings generally relate to methods and apparatuses for electrical wire, and more particularly to a silicone free fire safety wire construction.

### B. Background

Fire safety cable (critical circuit cable) finds application in providing electrical power to equipment and systems that are required to function during a fire. These systems may include fire alarm controllers, fire suppression equipment, sprinkler pumps in high rise buildings or other environments. This equipment needs to operate for a sufficient period of time to allow the safe evacuation of people from the location of the fire.

Fire performance cables are required to continue to operate and provide circuit integrity when they are subjected to fire. To meet some of the standards, cables must typically maintain electrical circuit integrity when heated to a specified temperature (e.g., 650, 750, 950, 1050° C.) in a prescribed way for a specified time (e.g., 15 minutes, 30 minutes, 60 minutes, 2 hours). In some cases, the cables are subjected to regular mechanical shocks, before, during and after the heating stage. Often they are also subjected to water jet or spray, either in the latter stages of the heating cycle or after the heating stage in order to gauge their performance against other factors likely to be experienced during a fire.

These requirements for fire performance cables up to a voltage of 600 V have been met previously by wrapping the conductor of the cable with tape made with glass fibers and treated with mica. Such tapes are wrapped around the conductor during production and then at least one insulative layer, one of which is a ceramifiable silicone, is subsequently applied. Upon being exposed to increasing temperatures, the non-silicone outer insulative layers are degraded and fall away, but the ceramified silicone and glass fibers hold the mica in place.

In the past the electrical power was provided through the use of mineral insulated cable. More recently, new and improved wire insulation material has been introduced for the safety cable (critical circuit) application. Today, a material of choice for wire insulation is a silicone rubber that has been specially formulated to form a ceramic-like layer when heated to the temperatures that are present in a fire.

The wire construction for safety cable (CI-“circuit integrity”) is typically a copper conductor. Over the copper conductor is applied the ceramifiable silicon rubber insulation. A jacket material is applied over the silicone insulation to provide mechanical protection during installation. One safety cable (CI) requirement for this family of cables is a fire test where the cables are installed in a manufacturer's specified system, and then tested for functionality in a furnace that models petroleum-fueled fire. In one test protocol the furnace is programmed to subject the test samples to a temperature rise on ambient to 1010° C. over a period of 2 hours. During this test the cables are energized to the voltage appropriate to the cables specified application. One test used is UL 2196 for 2 hours. To meet the requirements of the UL2196 test, electrical functionality must be maintained throughout the 2 hours and the following simulated fire hose water spray test.

The UL2196 test method described in these requirements is intended to evaluate the fire resistive performance of electrical cables as measured by functionality during a period of fire exposure, and following exposure to a hose stream. To maintain the functionality of electrical cables during a fire exposure the cables are tested using a fire resistive barrier. The fire resistive barrier is the cable jacketing if the jacketing is designed to provide fire resistance. If the cable jacketing is not designed to provide fire resistance, the electrical cables are either placed within a fire resistive barrier or installed within an hourly rated fire resistive assembly. Fire resistive cables intended to be installed with a non-fire resistive barrier (such as conduit) are tested with the non-fire resistive barrier included as part of the test specimen. Otherwise fire resistive cables incorporating a fire resistive jacket are tested without any barrier. To demonstrate each cable's ability to function during the test, voltage and current are applied to the cable during the fire exposure portion of the test, and the electrical and visual performance of the cable is monitored. The cable is not energized during the hose spray, but it is visually inspected and electrically tested after the hose spray. The functionality during a fire exposure of non-fire resistive electrical cables which are intended for installation within fire barriers or for installation within hourly rated fire resistive assemblies is determined by tests conducted in accordance with the UL Outline of Investigation for Fire Tests for Electrical Circuit Protective Systems, Subject 1724. Two fire exposures are defined: a normal temperature rise fire and a rapid temperature rise fire. The normal temperature rise fire is intended to represent a fully developed interior building fire. The rapid temperature rise fire is intended to represent a hydrocarbon pool fire. Two hose stream exposures are defined: a normal impact hose stream and a low impact hose stream. The low impact hose stream is applied only to cable intended to contain the identifying suffix “CI” to identify it as CI cable in accordance with the Standard for Cables for Power-Limited Fire-Alarm Circuits, UL 1424, and in accordance with the Standard for Cables for Non-Power-Limited Fire-Alarm Circuits, UL 1425. In addition to fire alarm cables referenced in UL 1424 and UL1425, power cables can also be approved for critical circuit applications. These power cables must meet the performance requirements listed in UL 44. Type RHH, RHW2, RHW and others of this standard if able to pass UL2196 can be qualified for CI applications.

In addition to the UL 2196 test, the circuit integrity (CI) must also meet the electrical requirements for non-CI rated cable. One of the requirements for this family of cables is long term insulation resistance. For this test, a copper conductor, with only the silicone rubber used as insulation, is tested at the specified voltage while the cable is immersed in 90° C. water. The insulation resistance is monitored periodically. The decrease in resistance must level out at a value above the minimum required. One of the requirements is specified in UL 44. This silicone compound can pass the requirements of UL 2196, but is unable to meet the requirements of UL 44 for insulation resistance long term in 90° C. water at rated voltage.

This UL 44 test specifies the requirements for single-conductor and multiple-conductor thermoset-insulated wires and cables rated 600 V, 1000 V, 2000 V, and 5000 V, for use in accordance with the rules of the Canadian Electrical Code (CEC), Part 1, CSA C22.1, in Canada, Standard for Electrical Installations, NOM-001-SEDE, in Mexico, and the National Electrical Code (NEC), NFPA-70, in the United States of America.

Mineral-insulated copper-clad cable is a variety of electrical cable made from copper conductors inside a copper sheath, insulated by inorganic magnesium oxide powder. The name is often abbreviated to MICC or MI cable.

MI cable is made by placing copper rods inside a circular copper tube and filling the spaces with dry magnesium oxide powder. The overall assembly is then pressed between rollers to reduce its diameter (and increase its length). Up to seven conductors are often found in an MI cable, with up to 19 available from some manufacturers.

Since MI cables use no organic material as insulation (except at the ends), they are more resistant to fires than plastic-insulated cables. MI cables are used in critical fire protection applications such as alarm circuits, fire pumps, and smoke control systems. In process industries handling flammable fluids MI cable is used where small fires would otherwise cause damage to control or power cables. MI cable is also highly resistant to ionizing radiation and so finds applications in instrumentation for nuclear reactors and nuclear physics apparatus. MI cables may be covered with a plastic sheath, colored for identification purposes. The plastic sheath also provides additional corrosion protection for the copper sheath. The metal tube shields the conductors from electromagnetic interference. Up until now, MI cable were the only cables capable of passing the 600 V certification by being tested at 600 V. All polymeric UL 2196 systems, up to this design, are certified at 600 V by being tested at 480 V. This allows for polymeric systems usage in the United States, but Canada requires systems to be tested at their certified voltage.

### II. SUMMARY

In accordance with one aspect of the present teachings, an electric wire utilizes a unique heat stable layer construction to prevent shorting of the conductor, without the use of silicone.

In accordance with one aspect of the present teachings, an electric wire has a mica layer that is folded over itself with a cross-linked polyethylene extruded over the mica layer.

In accordance with one aspect of the present teachings, an electric wire is provided that can be tested and certified at up to 600 V.

In accordance with one aspect of the present teachings, an electric wire with a heat stable layer that allows the conductor to expand during heating without breaking.

In accordance with one aspect of the present teachings, an electric wire has helically wrapped heat stable tape, which creates an impenetrable layer to prevent shorts.

Other benefits and advantages will become apparent to those skilled in the art to which it pertains upon reading and understanding of the following detailed specification.

### III. BRIEF DESCRIPTION OF THE DRAWINGS

The present teachings are described hereinafter with reference to the accompanying drawings.

FIG. 1 shows a cross-sectional view of the wire;

FIG. 1A shows a cross-sectional view of the wire showing the fold of the tape layer;

FIG. 2 shows a cross-sectional view of another embodiment of the wire;

FIG. 3 shows a cross-sectional view of the metal conductor of FIG. 2 and the first mica layer folded around the conductor;

FIG. 3A shows a perspective view of the first fiberglass layer wrapped clockwise around the first mica layer of FIG. 3;

FIG. 3B shows a cross-sectional view of the first mica layer, the first fiberglass layer, and the second mica layer folded around the first fiberglass layer of FIG. 2;

FIG. 3C shows a perspective view of the second fiberglass layer wrapped counterclockwise around the second mica layer of FIG. 2;

FIG. 4 shows a cutaway perspective view of the wire of FIG. 2;

FIG. 5 shows a cutaway perspective view of the wire of FIG. 1; and

FIG. 6 shows a cutaway perspective view of the wire of FIG. 2.

### IV. DETAILED DESCRIPTION

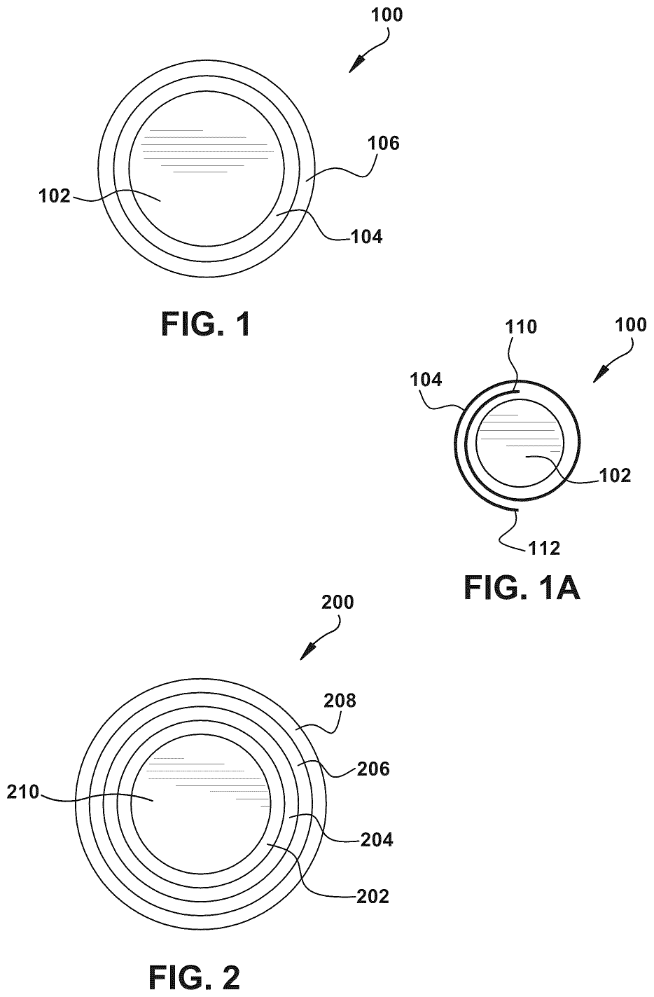

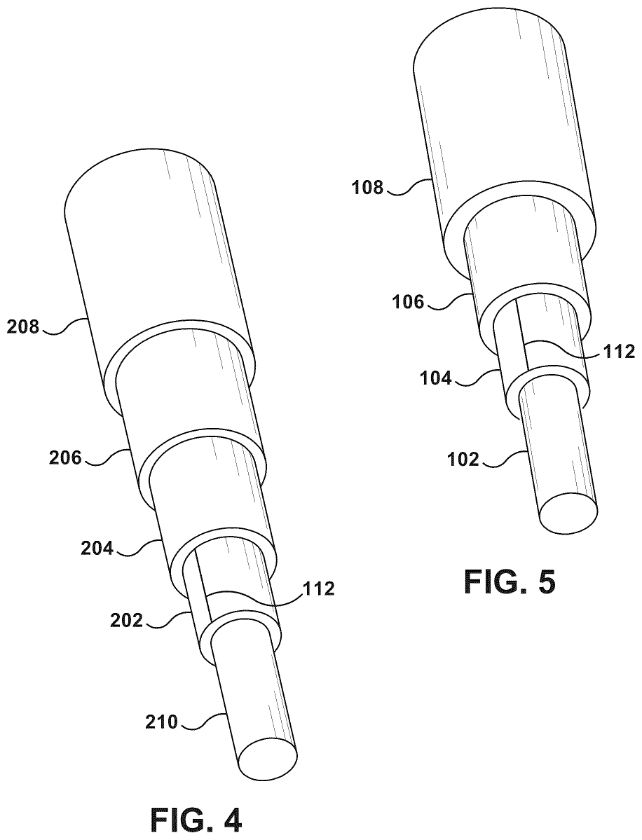

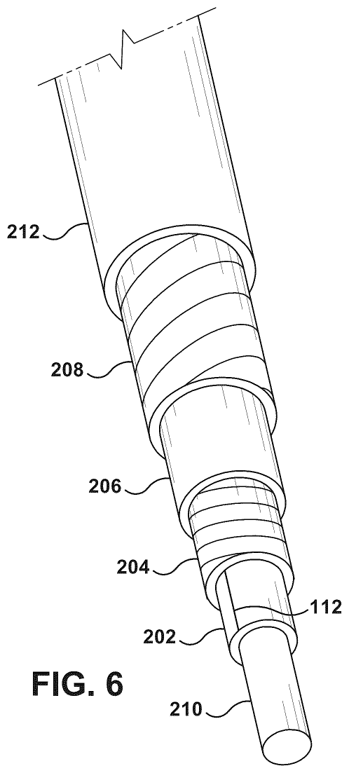

In reference to the FIGS. 1-6, an electric wire 100 is shown. The wire 100 has a metal conductor 102 with a heat stable tape layer 104 folded around the conductor 102, in direct contact with the conductor 102. As shown in FIG. 1A, the heat stable synthetic tape layer 104 has a first edge 110 and a second edge 112, wherein the second edge 112 wraps around the conductor 102 and overlaps the first edge 110 by at least 180 degrees in the cross-section. The overlap of second edge 112 over the first ledge by between about 20 degrees to about 180 degrees in the cross-section. An extruded layer 106 of cross-linked polyethylene is extruded onto the heat stable synthetic tape layer 104. The wire 100 does not contain silicone as silicone can make the conductor 102 brittle. The folded heat stable synthetic tape layer 104, shown in FIG. 1A, allows the conductor 102 to expand during heating, without breaking.

With continuing reference to FIG. 2, a wire 200 has a conductor 210, a first heat stable synthetic tape layer 202 folded around the conductor 210 in direct contact with the conductor 210, a second synthetic heat stable tape layer 204, which is helically wrapped around the first heat stable synthetic tape layer 202, a third synthetic heat stable tape layer 206, which is helically wrapped around the second synthetic heat stable tape layer 204, and an extruded layer 208 extruded around the third synthetic heat stable tape layer 206. As shown in FIG. 1A, the first synthetic heat stable tape layer 202 has a first edge 110 and a second edge 112, wherein the second edge 112 wraps around the conductor 210 and overlaps the first edge 110 by at least 180 degrees in the cross-section. In another aspect of the present teaching, the second edge 112 wraps around the conductor 210 and overlaps the first edge 110 by at least 20 degrees in the cross-section, the second edge 112 wraps around the conductor 210 and overlaps the first edge 110 by at least 40 degrees in the cross-section, the second edge 112 wraps around the conductor 210 and overlaps the first edge 110 by at least 60 degrees in the cross-section, the second edge 112 wraps around the conductor 210 and overlaps the first edge 110 by at least 80 degrees in the cross-section, the second edge 112 wraps around the conductor 210 and overlaps the first edge 110 by at least 100 degrees in the cross-section, the second edge 112 wraps around the conductor 210 and overlaps the first edge 110 by at least 120 degrees in the cross-section, the second edge 112 wraps around the conductor 210 and overlaps the first edge 110 by at least 140 degrees in the cross-section, and the second edge 112 wraps around the conductor 210 and overlaps the first edge 110 by at least 160 degrees in the cross-section.

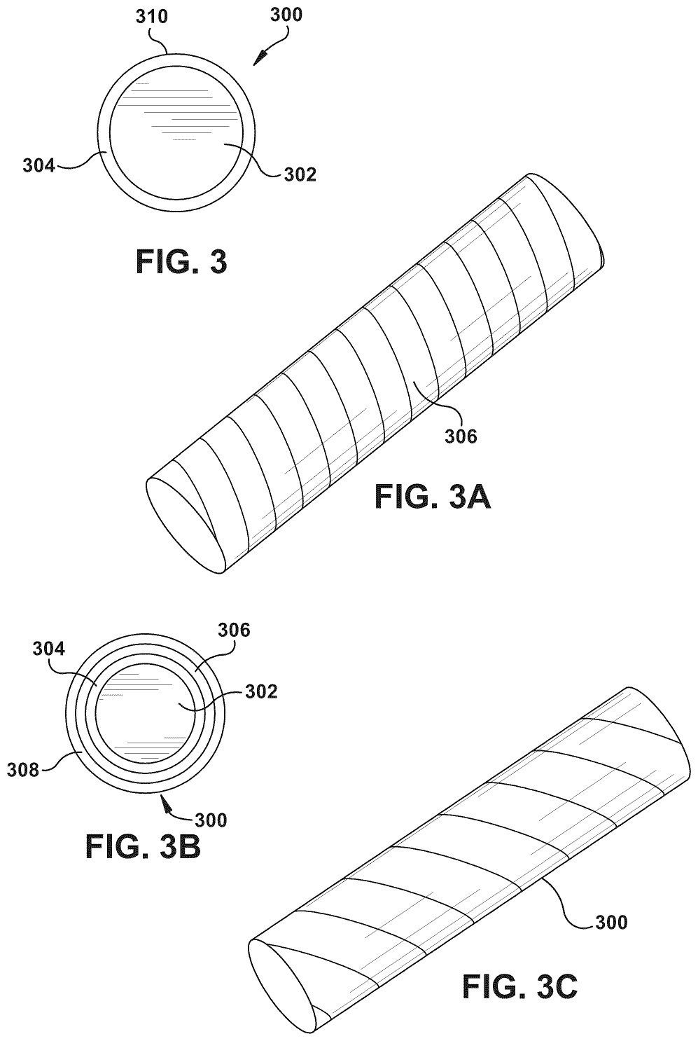

With continuing reference to FIGS. 3, 3A, 3B, 3C a wire 300 is shown. The wire 300 has a conductor 302, a first synthetic heat stable tape layer 304 folded around the conductor 302, in direct contact with the conductor 302, a second synthetic heat stable tape layer 306, which is helically wrapped around the first synthetic heat stable tape layer 304, and an extruded layer 308 extruded around the second synthetic heat stable tape layer 306. As shown in FIG. 1A, the first synthetic heat stable tape layer 304 has a first edge 110 and a second edge 112, wherein the second edge 112 wraps around the conductor 302 and overlaps the first edge 110 by at least 180 degrees in the cross-section. In another aspect of the present teaching, the second edge 112 wraps around the conductor 302 and overlaps the first edge 110 by at least 20 degrees in the cross-section, the second edge 112 wraps around the conductor 302 and overlaps the first edge 110 by at least 40 degrees in the cross-section, the second edge 112 wraps around the conductor 302 and overlaps the first edge 110 by at least 60 degrees in the cross-section, the second edge 112 wraps around the conductor 302 and overlaps the first edge 110 by at least 80 degrees in the cross-section, the second edge 112 wraps around the conductor 302 and overlaps the first edge 110 by at least 100 degrees in the cross-section, the second edge 112 wraps around the conductor 302 and overlaps the first edge 110 by at least 120 degrees in the cross-section, the second edge 112 wraps around the conductor 302 and overlaps the first edge 110 by at least 140 degrees in the cross-section, and the second edge 112 wraps around the conductor 302 and overlaps the first edge 110 by at least 160 degrees in the cross-section.

With respect to the present teachings above, it is understood that the wires can have conductors with 18 AWG to 750 MCM. In addition, the conductors can have a diameter of between about 0.07 inches and about 0.88 inches, the conductors with the folded tape have a diameter of between about 0.125 inches and about 2.0 inches, the conductors with the folded tape and extruded layer have a diameter of between 0.160 inches and about 1.160 inches. The heat stable synthetic tape layers in one aspect of the present teachings are synthetic mica tape. The extruded layer in one aspect of the present teaching is crosslinked polyethylene. The wires of the present teaching do not contain silicone.

Clause 1—An electric wire including a metal conductor, wherein the conductor is about 750 MCM or smaller, wherein the metal conductor has a top and a bottom, a first synthetic mica layer in direct contact with the metal conductor, wherein the first synthetic mica layer has a first edge and a second edge, wherein the first edge and the second edge are substantially parallel to one another, wherein the second edge overlaps the first edge by at least 180 degrees on a cross-sectional view, a second synthetic mica layer, wherein the second mica layer is helically wrapped around the first synthetic mica layer, a third synthetic mica layer, wherein the third synthetic mica layer is helically wrapped around the second synthetic mica layer, wherein electric wire contains no silicone, and a polyethylene layer, wherein the polyethylene layer is extruded over the third synthetic mica layer, wherein the electric wire contains no silicone.

Clause 2—An electric wire including a metal conductor, a first synthetic heat stable tape layer in direct contact with the metal conductor, wherein the first synthetic heat stable tape layer has a first edge and a second edge, wherein the first edge and the second edge are substantially parallel to one another, wherein the second edge overlaps the first edge by at least 20 degrees on a cross-sectional view, a second synthetic heat stable tape layer, wherein the second synthetic heat stable tape layer is helically wrapped around the first synthetic heat stable tape layer, and an extruded layer, wherein the extruded layer is extruded over the second synthetic heat stable tape layer, wherein the electric wire contains no silicone.

Clause 3—The electric wire of clause 2, wherein the conductor has an MCM of about 750 or smaller.

Clause 4—The electric wire of clauses 2 or 3, wherein the wire further includes a third synthetic heat stable tape layer, wherein the third synthetic heat stable tape layer is helically wrapped around the second synthetic heat stable tape layer.

Clause 5—The electric wire of clauses 2-4, wherein the extruded layer is crosslinked polyethylene.

Clause 6—The electric wire of clauses 2-5, wherein the synthetic heat stable tape layers are synthetic mica layers.

Clause 7—The electric wire of clauses 2-6, wherein the second edge overlaps the first edge by at least 40 degrees on a cross-sectional view.

Clause 8—The electric wire of clause 7, wherein the second edge overlaps the first edge by at least 60 degrees on a cross-sectional view.

Clause 9—The electric wire of clause 7 or 8, wherein the second edge overlaps the first edge by at least 80 degrees on a cross-sectional view.

Clause 10—The electric wire of clauses 7-9, wherein the second edge overlaps the first edge by at least 100 degrees on a cross-sectional view.

Clause 11—The electric wire of clauses 7-10, wherein the second edge overlaps the first edge by at least 120 degrees on a cross-sectional view.

Clause 12—The electric wire of clauses 7-11, wherein the second edge overlaps the first edge by at least 140 degrees on a cross-sectional view.

Clause 13—The electric wire of clauses 7-12, wherein the second edge overlaps the first edge by at least 160 degrees on a cross-sectional view.

Clause 14—The electric wire of clauses 7-13, wherein the second edge overlaps the first edge by at least 180 degrees on a cross-sectional view.

The present teachings have been described, hereinabove. It will be apparent to those skilled in the art that the above methods and apparatuses may incorporate changes and modifications without departing from the general scope of the present teachings. It is intended to include all such modifications and alterations insofar as they come within the scope of the appended claims or the equivalents thereof. Although the description above contains much specificity, this should not be construed as limiting the scope of the present teachings, but as merely providing illustrations of some of the aspects of the present teachings. Various other aspects and ramifications are possible within its scope.

Furthermore, notwithstanding that the numerical ranges and parameters setting forth the broad scope of the present teachings are approximations, the numerical values set forth in the specific examples are reported as precisely as possible. Any numerical value, however, inherently contains certain errors necessarily resulting from the standard deviation found in their respective testing measurements.

What is claimed is:

1. An electric wire comprising:
a metal conductor, wherein the conductor is about 750 MCM or smaller, wherein the metal conductor has a top and a bottom;
a first synthetic mica layer in direct contact with the metal conductor, wherein the first synthetic mica layer has a first edge and a second edge, wherein the first edge and the second edge are substantially parallel to one another, wherein the second edge overlaps the first edge by at least 180 degrees on a cross-sectional view;
a second synthetic mica layer, wherein the second mica layer is helically wrapped around the first synthetic mica layer;
a third synthetic mica layer, wherein the third synthetic mica layer is helically wrapped around the second synthetic mica layer, wherein electric wire contains no silicone; and
a polyethylene layer, wherein the polyethylene layer is extruded over the third synthetic mica layer, wherein the electric wire contains no silicone.

2. An electric wire comprising:
a metal conductor;
a first synthetic heat stable tape layer in direct contact with the metal conductor, wherein the first synthetic heat stable tape layer has a first edge and a second edge, wherein the first edge and the second edge are substantially parallel to one another, wherein the second edge overlaps the first edge by at least 20 degrees on a cross-sectional view;
a second synthetic heat stable tape layer, wherein the second synthetic heat stable tape layer is helically wrapped around the first synthetic heat stable tape layer; and
an extruded layer, wherein the extruded layer is extruded over the second synthetic heat stable tape layer, wherein the electric wire contains no silicone.

3. The electric wire of claim 2, wherein the conductor has an MCM of about 750 or smaller.

4. The electric wire of claim 2, wherein the wire further comprises:
a third synthetic heat stable tape layer, wherein the third synthetic heat stable tape layer is helically wrapped around the second synthetic heat stable tape layer.

5. The electric wire of claim 2, wherein the extruded layer is crosslinked polyethylene.

6. The electric wire of claim 2, wherein the synthetic heat stable tape layers are synthetic mica layers.

7. The electric wire of claim 2, wherein the second edge overlaps the first edge by at least 40 degrees on a cross-sectional view.

8. The electric wire of claim 7, wherein the second edge overlaps the first edge by at least 60 degrees on a cross-sectional view.

9. The electric wire of claim 8, wherein the second edge overlaps the first edge by at least 80 degrees on a cross-sectional view.

10. The electric wire of claim 9, wherein the second edge overlaps the first edge by at least 100 degrees on a cross-sectional view.

11. The electric wire of claim 10, wherein the second edge overlaps the first edge by at least 120 degrees on a cross-sectional view.

12. The electric wire of claim 11, wherein the second edge overlaps the first edge by at least 140 degrees on a cross-sectional view.

13. The electric wire of claim 12, wherein the second edge overlaps the first edge by at least 160 degrees on a cross-sectional view.

14. The electric wire of claim 13, wherein the second edge overlaps the first edge by at least 180 degrees on a cross-sectional view.
